(19) United States
(12) Patent Application Publication
(10) Pub. No.: US 2012/0229473 A1
(43) Pub. Date: Sep. 13, 2012

(54) Dynamic Animation in a Mobile Device

(75) Inventor: Wendy W. TAM, Austin, TX (US)

(73) Assignee: Airgini Group, Inc., Santa Clara, CA (US)

(21) Appl. No.: 12/174,613

(22) Filed: Jul. 16, 2008

Related U.S. Application Data
(60) Provisional application No. 60/959,979, filed on Jul. 17, 2007.

(51) Int. Cl. G06T 13/00

(52) U.S. Cl. 345/473

(57) ABSTRACT

Method and system for monitoring occurrence of an event using dynamic animation are disclosed. The method includes identifying an event to be dynamically animated, defining a set of trigger conditions of the event to be monitored, monitoring the event according to the set of trigger conditions, computing a display unit in accordance with a comparison of a status of the event to a corresponding trigger condition of the event, creating a dynamic animation for display using the display unit, and displaying the dynamic animation on a display.

### RELATED APPLICATION

This application also claims the benefit of U.S. provisional application No. 60/959,979, “Method and System for Monitoring Occurrence of an Event Using Dynamic Animation” filed Jul. 17, 2007, which is incorporated herein in its entirety by reference.

### FIELD OF THE INVENTION

The present invention generally relates to the field of data communication. In particular, the present invention relates to a method and system for providing dynamic animation of events in a mobile device.

### BACKGROUND OF THE INVENTION

The recent proliferation of electronic devices for communication, information management and recreation has taken routine computing power far away from the desk-bound personal computer. Users are using devices such as cell phones, camera phones, and personal digital assistants (PDAs), not only in the office and in the home, but also in the field and on the road. There is a diverse range of possible applications for such devices, including communication, business, navigation, entertainment and even managing basic daily activities. Many users today only use a single device for a single task, for example, using cell phones for making and receiving phone calls. However, these devices are no longer single-function devices. They are capable of creating various types of data, for instance, electronic mail, voice messages, photos, video, etc. Increasing the number of functions of a device increases the level of personalization to the users.

FIG. 8A illustrates a convention approach mobile devices are used to receive information, such as to receive instant messages and other forms of text messages. In this form of communication (as shown by numeral 802), information in the form of short message service (SMS), multimedia messaging service (MMS), wireless application protocol (WAP) push, and other active contents are pushed onto the mobile device, whether the user wants to receive the information or not. A drawback of this push method of communication is that it is disruptive to the user because it frequently demands for the user's attention. The user may be overwhelmed with information and most of the information received may be treated by the user as spam data.

FIG. 8B illustrates another conventional approach mobile devices are used to get information, such as checking stock prices or sports scores. In this form of communication (as shown by numeral 804), information is pulled by the user, such as in the form of navigating, browsing, or checking for information update on the Internet. One drawback of this mode of communication is that the user has to devote the time and effort to navigate through multiple links or web pages in order to retrieve the information, which is time consuming and sometimes the information interested to the user is not yet available, for example, the final score is not available because the game has not yet finished.

Therefore, there is a need for a method and system for communicating information with a mobile device that addresses the drawbacks of conventional methods described above. In particular, there is a need for delivering information the user wants and at the same time reducing the disruption to the user and user's time in obtaining such information.

### SUMMARY

The present invention generally relates to the field of data communication. In particular, the present invention relates to a method and system for providing dynamic animation of events in a mobile device.

In one embodiment, a method for providing dynamic animation of events in a mobile device includes identifying an event to be dynamically animated, defining a set of trigger conditions of the event to be monitored, monitoring the event according to the set of trigger conditions, computing a display unit in accordance with a comparison of a status of the event to a corresponding trigger condition of the event, creating a dynamic animation for display using the display unit, and displaying the dynamic animation on a display.

In another embodiment, a system for generating dynamic animation of events includes at least one processing unit for executing computer programs, a user interface for receiving and communicating information with a user, and a memory for storing data in association with the monitoring occurrence of an event using dynamic animation. The system further includes a provisioning module for accessing resources stored in the system, a user profile module for creating and storing user profiles, a data optimization module for optimizing data for transmission between the system and mobile clients, a dynamic alert monitoring module for monitoring user-defined events, and a sponsored message processing module for handling advertising requests from advertisers.

In yet another embodiment, a computer program product for monitoring occurrence of an event using dynamic animation including a medium storing executable program code, the computer program product includes a widget framework that operates widgets for monitoring occurrence of an event, a screen saver framework that displays occurrence of the event as a dynamic animation, a binary processing engine that runs screen saver scripts and widget scripts in binary format, and a mobile application programming interface wrapper that provides a layer of abstraction for creating a platform independent environment.

### BRIEF DESCRIPTION OF THE DRAWINGS

The aforementioned features and advantages of the invention, as well as additional features and advantages thereof, will be more clearly understandable after reading detailed descriptions of embodiments of the invention in conjunction with the following drawings.

FIG. 1 illustrates a system for supporting a dynamic push based animation according to embodiments of the present invention.

FIG. 2 illustrates software components of a mobile client according to embodiments of the present invention.

FIGS. 3A-3C illustrate software components of the dynamic animation system according to embodiments of the present invention.

FIG. 4 illustrates a method for monitoring an event according to embodiments of the present invention.

FIG. 5 illustrates a screen control flow diagram for a mobile client according to embodiments of the present invention.

FIGS. 6A-6B illustrate examples of a script engine according to embodiments of the present invention.

FIG. 7 illustrates a method of implementing dynamic animation according to embodiments of the present invention.

FIG. 8A illustrates a convention approach mobile devices are used to receive information.

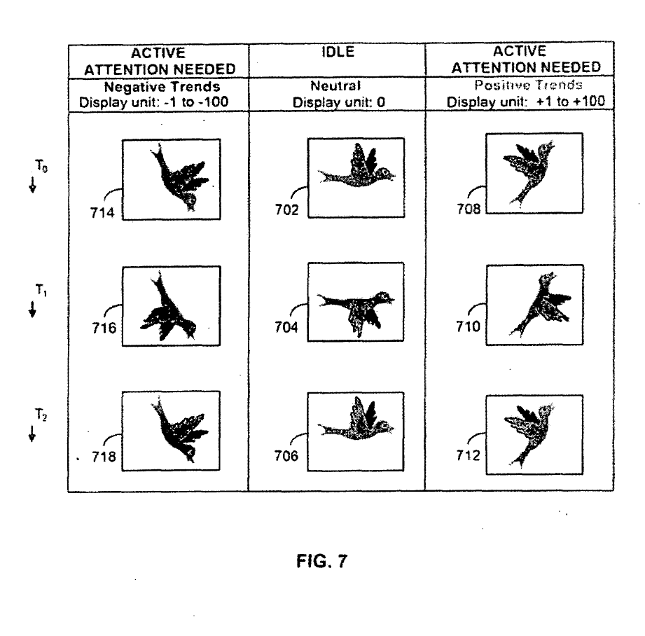

FIG. 8B illustrates another conventional approach mobile devices are used to get information.

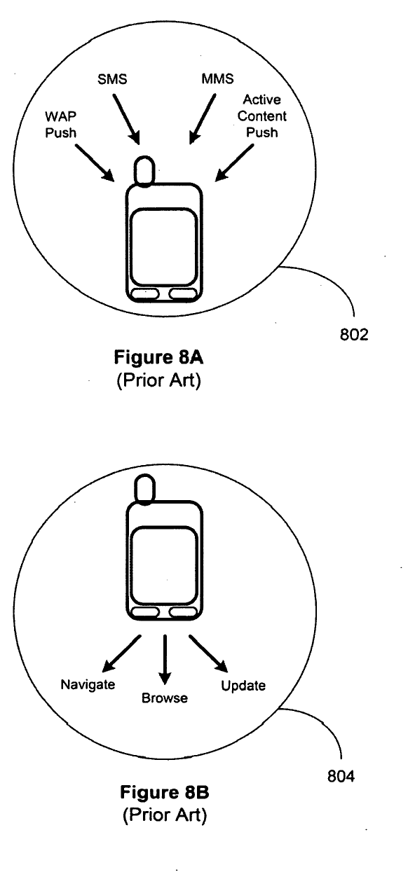

### DESCRIPTION OF EMBODIMENTS

Methods and systems for providing dynamic animation of events in a mobile device are disclosed. The following descriptions are presented to enable any person skilled in the art to make and use the invention. Descriptions of specific embodiments and applications are provided only as examples. Various modifications and combinations of the examples described herein will be readily apparent to those skilled in the art, and the general principles defined herein may be applied to other examples and applications without departing from the spirit and scope of the invention. Thus, the present invention is not intended to be limited to the examples described and shown, but is to be accorded the widest scope consistent with the principles and features disclosed herein.

Some portions of the detailed description that follows are presented in terms of flowcharts, logic blocks, and other symbolic representations of operations on information that can be performed on a computer system. A procedure, computer-executed step, logic block, process, etc., is here conceived to be a self-consistent sequence of one or more steps or instructions leading to a desired result. The steps are those utilizing physical manipulations of physical quantities. These quantities can take the form of electrical, magnetic, or radio signals capable of being stored, transferred, combined, compared, and otherwise manipulated in a computer system. These signals may be referred to at times as bits, values, elements, symbols, characters, terms, numbers, or the like. Each step may be performed by hardware, software, firmware, or combinations thereof.

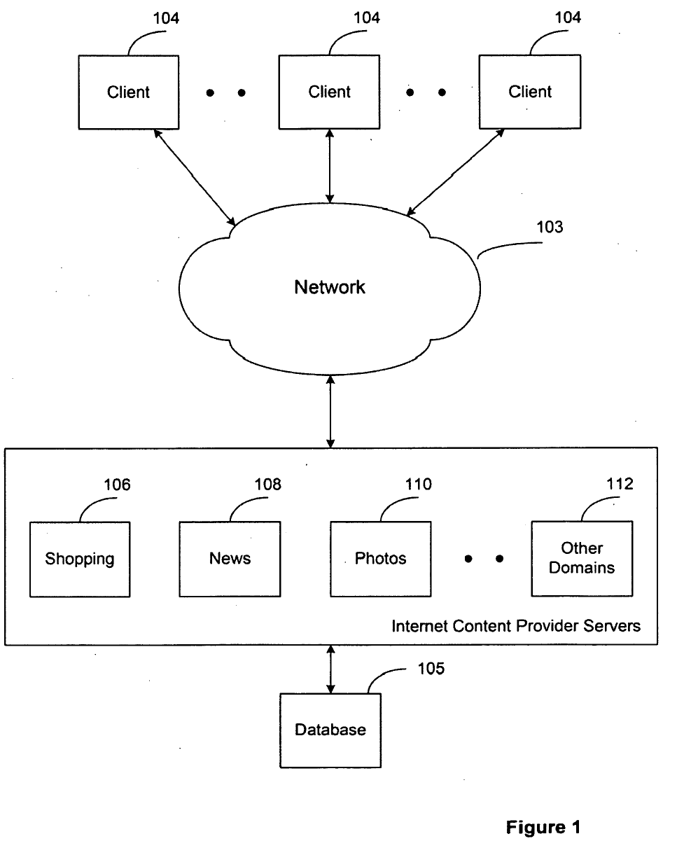

FIG. 1 illustrates a system for supporting a dynamic push based animation according to embodiments of the present invention. The system includes one or more Internet content provider servers 102, databases 105, and one or more clients 104. The servers 102 interface with the clients 104 via a communication network 103. The Internet content provider servers 102 are host servers operable to provide content to clients 104 via the network 103. One or more of the servers host web sites and include the news and search functions. The databases 105 are operable to store data provided by the servers 102 and/or clients 104. The databases can communicate with the servers 102 or clients 104 via the network 103. The databases can store data items included in the web pages, such as news pages.

Alternatively, the servers 102 may include the databases, processors, switches, routers, interfaces, and other components and modules. Each of the servers 102 may comprise one or more servers, or may be combined into a lesser number of servers than shown, depending on computational and/or distributed computing requirements. The servers 102 may be located at different locations relative to each other. The databases may also be separately connected to the servers 102. There may be more or less than two databases, depending on computational and/or distributed computing requirements. The databases may be located at different locations relative to each other and the servers 102.

Each of the clients 104 may be a general purpose computer, such as a personal computer, having a central processing unit (CPU), a memory, an input device, and an output device. Other computer system configurations, including Internet appliances, hand-held devices, wireless devices, portable devices, wearable computers, cellular or mobile phones, portable digital assistants (PDAs), multi-processor systems, microprocessor-based or programmable consumer electronics, set-top boxes, network PCs, mini-computers, and the like may also be implemented as the clients 104. Clients 104 include one or more applications, program modules, and/or sub-routines. As an example, clients 106 may include a browser application (e.g., Internet Explorer, etc.) and a graphical user interface (GUI) to access web sites and web pages provided by the servers 102 and data stored at the databases 105. Clients 104 may be remote from each other, the servers 102, and/or the databases.

The network 103 is a communications network, such as a local area network (LAN), a wide area network (WAN), or the Internet. When the network 103 is a public network, security features such as virtual private networks (VPN) or secure sockets layer (SSL) secure transport may be included to ensure authorized access within the system.

The servers 102 further include a plurality of individual domains, for example, shopping domain 106, news domain 108, photos domain 110, and other domains 112. A domain is a computer system implemented with different hardware and software for a specific application, such as the shopping applications, news applications, and photo applications. Other domains may include games, finance, weather, and search. These applications implement Web 2.0 functionalities using a combination of hyper text markup language (HTML), cascading style sheets (CSS), JavaScript and “Asynchronous JavaScript and XML” (AJAX).

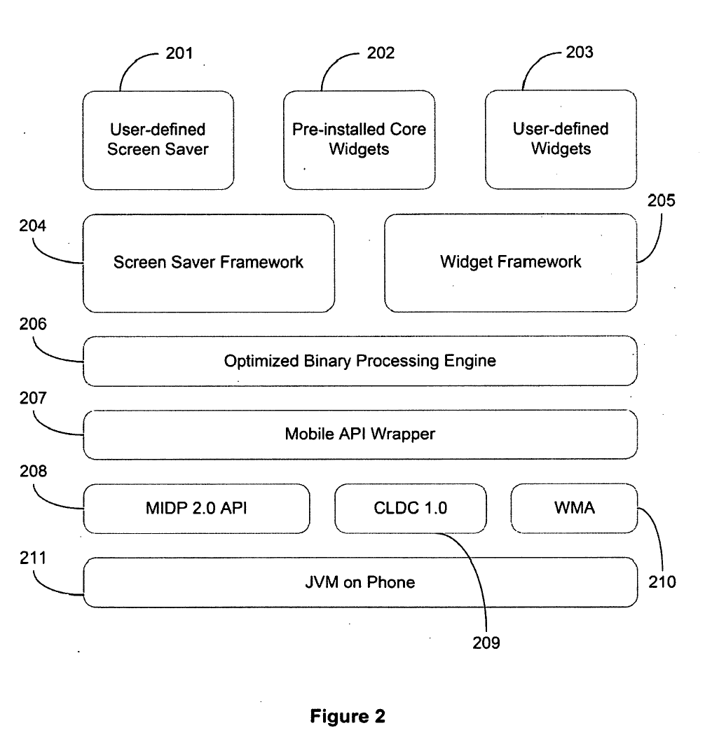

FIG. 2 illustrates software components of a mobile client according to embodiments of the present invention. As shown in FIG. 2, software components of the mobile client include a user-defined screen saver 201, pre-installed core widgets 202, user-defined widgets 203, a screen saver framework 204, a widget framework 205, an optimized binary processing engine 206, a mobile API (application program interface) wrapper 207, a MIDP2.0 API 208, a CLDC1.0 209, a WMA 210, and a JVM on phone 211. According to embodiments of the present invention, the user-defined screen saver 210 may be created either by a user or by a developer. The pre-installed core widgets may include weather, news, finance, games, shopping, and portal discovery widgets, which may be built-in widgets that come with the application or mobile device. The user-defined widgets 203 may be created by a user or by a developer. The screen saver framework 204 provides functions for screen saver hot plug. The widget framework 205 provides functions for widget hot plug and handles user interface components of the mobile device. The optimized binary processing engine 206 runs screen saver scripts and widget scripts in binary format. The mobile application programming interface (API) wrapper 207 provides a layer of abstraction on mobile API for creating a platform independent environment. The MIDP2.0 API 208 provides the Mobile Information Device Profile 2.0 API on Java handsets. The CLDC1.0 209 provides the Connected Limited Device Configuration API on Java handsets. The WMA 210 provides the Wireless Messaging API on Java handsets. The JVM on Phone 211 provides the Java Virtual Machine on Java handsets.

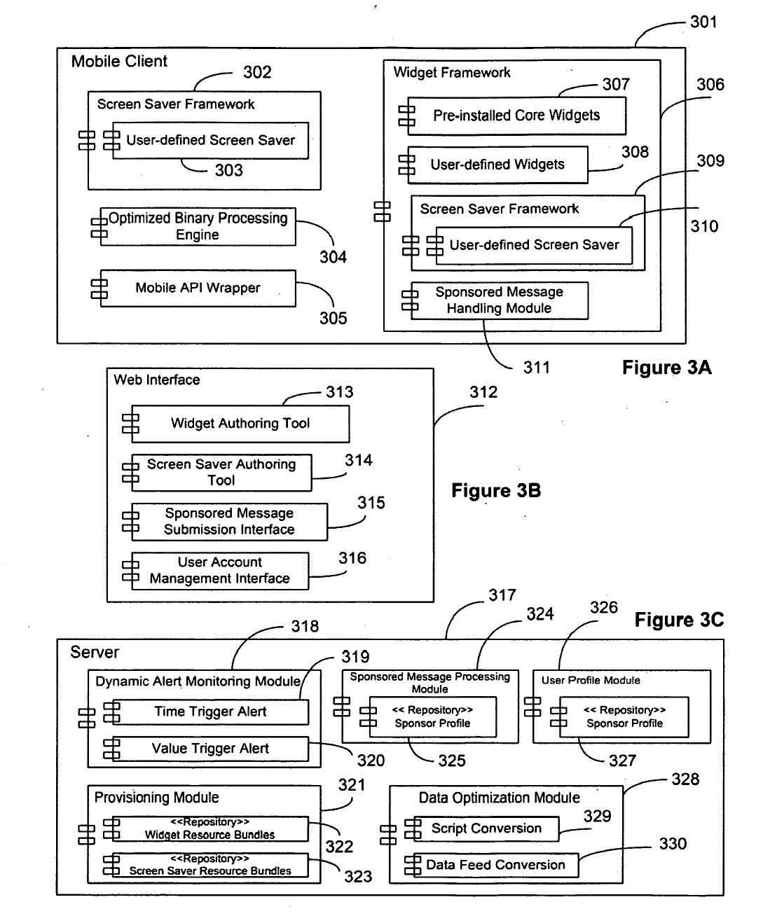

FIGS. 3A-3C illustrate software components of the dynamic animation system according to embodiments of the present invention. FIG. 3A illustrates software plug-ins for a mobile client 301 according to embodiments of the present invention. As shown in FIG. 3A, software plug-ins used for the mobile client 301 include a screen saver framework 302 which in turn includes a user-defined screen saver 303, an optimized binary processing engine 304, a mobile API wrapper 305, and a widget framework 306. The widget frame 306 further includes pre-installed core widgets 307, user-defined widgets 308, a watchlist manager 309 which in turn includes user-defined watch items 310 (also referred to as watch event or event for short), and a sponsored message handling module 311. The screen saver framework 302 provides functions for screen saver hot plug, and the user-defined screen saver may be created either by a user or by a developer. The optimized binary processing engine 304 runs screen saver scripts and widget scripts in binary format. The mobile API wrapper 305 provides a layer of abstraction on mobile API for creating a platform independent environment.

The widget framework 306 provides functions for widget hot plug and handles user interface components for the mobile client 301. The pre-installed core widgets 307 may include weather, news, finance, games, search, and portal discovery widget that are shipped with the application without the need to download by users. The user-defined widgets 308 may be created by a user or by a developer. The watchlist manager 309 handles creation, deletion and modification of watch items, and maintains a list watch items for access. The user-defined watch items 310 may be created by users to ask the system to monitor change of events for them. The sponsored message handling module 311 retrieves and displays sponsored messages.

FIG. 3B illustrates software plug-ins used for web interface 312 according to embodiments of the present invention. In this example, the software plug-ins for the web interface 312 includes a widget authoring tool 313, a screen saver authoring tool 314, a sponsored message submission interface 315, and a user account management interface 316.

The widget authoring tool 313 allows users or developers to create widgets in a user friendly environment. The screen saver authoring tool 314 allows users or developers to create different themes for the screen saver that reflect their personal preferences in a user-friendly environment. The sponsored message submission interface 315 allows advertisers to submit sponsor advertisement and to manage their accounts. The user account management interface 316 allows users to manage their accounts and to add, modify, or remove widgets and screen savers.

FIG. 3C illustrates backend components of a server that communicates with mobile clients according to embodiments of the present invention. In the example shown in FIG. 3C, the server 317 includes a dynamic alert monitoring module 318, a provisioning module 321, a sponsored message processing module 324, a user profile module 326, and a data optimization module 328.

The dynamic alert monitor module 318 includes a time-triggered alert 319 and a value-triggered alert 320, and it monitors new events defined by users and sends alert to the mobile client when the requirements are met. The time-triggered alert 319 handles time-based events. For example when a user defines a time-based watch event with a time trigger value of “5 P.M. daily”, the time-triggered alert 319 sends an alert to the user at 5 P.M. every day. On the other hand, the value-triggered alert 320 triggers alert when the monitoring value passes the value defined by users.

The provisioning module 321 includes widget resource bundles 322 and screen saver resource bundles 323, and it stores and provides access to widget and screen saver resources. According to embodiments of the present invention, the widget resource bundles 322 stores widgets, and the screen saver resource bundles 323 stores screen savers.

The sponsored message processing module 324 validates and handles advertising request from advertisers. It further includes a sponsor profile 325 for storing profiles of advertisers and their corresponding advertisements.

The user profile module 326 handles user profiles such as user preferences, widgets, and screen saver information about the users. It further includes user profiles 327 for storing details of user profiles.

The data optimization module 328 optimizes data to minimize traffic between the server and the mobile client, and ensures the data can be read by the mobile client. It further includes a script conversion 329 and a data feed conversion 330. The script conversion unit 329 converts the scripts to binary compacted format packed with the image and sound resources. The data feed conversion 330 converts the data feed to binary compacted format for transmission and so the mobile client can read the binary.

According to embodiments of the present invention, the widget engine described below may be used to implement a widget of the present invention. Persons of ordinary skill in the art would appreciate that other implementations or other types of widget engines may be used to implement a widget. In addition, in the following discussions, methods of constructing and using the widgets are described for computing devices running Windows operating system. Persons of ordinary skill in the art would understand that similar implementations may be done for the Macintosh, UNIX, or Linux operating system.

The widget engine, also referred to as “engine” in this document, uses the Extensible Markup Language (XML) to define widgets and objects. This language forms a clear hierarchical structure for each object, the order the object is drawn in, and the order to associate the attributes of each object. An example of a widget is shown as follows:

<widget debug=“on”>
<window title-“Sample Widget”>
<name>main window</name>
<width>500</width>
<height>500</height>
<image src=“Images/Sun.png” name=“sun1”>
<hOffset>250</hOffset>
<vOffset>250</vOffset>
<alignment>menter</alignment>
</image>
<text data-“Click Here” size=“36” style=“bold”>
<name>text1</name>
<hOffset>250</hOffset>
<vOffset>100</vOffset>
<alignment>menter</alignment>
<onMouseUp>
sun1.opacity = (sun1.opacity / 100) * 90;
</onMouseUp>
</text>
</window>
</widget >

The widget reduces the opacity of an image by 10% every time the user clicks on the text that says “Click Here.” This sample widget is used to illustrate a few points. First, the structure of the widget uses a symmetrical language XML such that each object specifier (e.g. <text>) has a corresponding terminator (</text>). Within these pairs of specifiers and terminators, the attributes of the objects are defined, such as screen positions, alignments, etc. Second, objects defined in XML may be manipulated in JavaScript. Third, the name of objects begins with a letter. Only letters, numbers and underscores are allowed for a name. The XML description of a widget is stored in a file with the extension .kon. In practice, a widget may have many images and text objects, multiple JavaScript sections, and may create new objects at runtime using JavaScript to implement complex functionality. The following sections describe various embodiments of techniques and codes for creating a new widget.

There are two styles of tag notations in terms of the XML syntax, which are:

<image>
<src>images/image.png</src>
<name>myImage</name>
</image>
or:
<image src=“images/image.png” name=“myImage”/>

A user may mix and match the two tag notations as follows:

<image src=“images/image.png”>
<name>myImage</name>
</image>

Entities are an XML construct that allows a user to specify a character via a special escape sequence. Some characters that are used to parse the XML syntax are considered reserved. The symbol & is used as the entity escape start (and for that reason is also a reserved character). The standard set of entities is used to represent XML special characters:

&amp; &
&quot; “
&apos: '
&lt <
&gt >

A user may also use entities to specify a character by its unicode code point:

| | |
|---|---|
| &#32; | <space character, decimal> |
| &#x20; | <space character, hex> |

Since the XML engine looks for the <and > symbols to mark blocks of XML data, the JavaScript engine needs to have these symbols replaced with & it and & gt respectively. For example:

<onMouseUp>
if (x &lt; 5)
displayResults( );
</onMouseUp>

Alternatively, the user may use XML comments to hide the JavaScript code from the XML engine as is commonly done in HTML:

<onMouseUp>
<!--
if (x < 5)
displayResults( );
//-->
</onMouseUp>

In yet another approach, the user may use CDATA sections as follows:

<onMouseUp>
<![CDATA[
if (x < 5)
displayResults( );
]]>
</onMouseUp>

These alternative approaches make the code easier to read. In yet another approach, a user may put the XML parser in a “strict mode,” which enforces the rules of XML in ways the parser normally does not do. To enable the strict mode, the following line is added to the top of the XML file:

<?konfabulator xml-strict=“true”?>

In the strict mode, the following aspects of the program are enforced: 1) All attribute values are put into quotes; 2) No stray “&” characters are allowed in a normal text section; 3) Entities (things that start with “&”) are evaluated inside attribute values; 4) No double dash (“- -”) allowed inside a comment. For this reason, it is preferable to put code into CDATA blocks; and 5) If an external file is included, there is no need to replace entities such as & It in that file.

File paths in the widget engine are relative to the location of the XML file. This means a file reference without a directory (e.g. main.js) will be searched in the same directory as the XML file while one with a directory (e.g. javascript/main.js) will be searched in the specified subdirectory of the directory where the XML file resides. It is preferable not to use absolute paths (e.g. ones that begin with a /) since the disk layout of different computers may differ greatly.

In Windows machines, the files that make up a widget are stored in a .widget file. This is a standard ZIP file that has had its extension changed to .widget. The Windows versions of the widget engine can read the zipped up .widget files. This is also the format of choice when creating cross-platform widgets. In one example, a widget bundle has the following structure:

myWidget.widget
Contents
myWidget.kon
Resources
<any files used by the widget>

The .kon file contains the actual widget code (similar to the sample widget in the section above). In one implementation, the .kon file is contained in the Contents folder. A user may put resources, such as pictures, in it. Typically, the resources would be put into a Resources folder, as shown above.

If the user does not use the widget converter and instead decides to zip the files manually, this may be done on a Windows computer by right-clicking the widget folder and creating a ZIP file from that. It should be noted the user does not need to create a zipped up widget file for testing each time the user makes a change while developing the widget. The user may double-click the .kon file to achieve the same effect.

Note that the widget package should not be modified at run time. In other words, one should not use the widget package to store information inside of itself. While many widgets use preferences to store their settings, a widget may store information inside its own package. In addition, when the widget engine runs a zipped widget, it first unzips it into a special location and then runs it from there. This unzipping happens every time one runs the widget, so if information is stored in the widget's unzipped package, it may be overwritten. To accommodate widgets that need to store permanent data, a system widget DataFolder folder path may be used to store a widget's permanent information.

In another embodiment, a widget engine may support a flat-file format that is not zipped. When the flat-file format is not compressed, the size of a widget is larger than the size of the widget in the zip format. Since images take up most of a widget's size, the increase is about 15% on average because images are normally already in a compressed format (PNG, JPG) while text files are typically not compressed. The benefit of having the files compressed is that there is no need to store the files in RAM until actually needed because the files are file-mapped. By using this new format, the time for launching a widget application is reduced.

When a widget uses a flat file format, items such as Dynamic-Link Libraries (DLLs) that may have been packaged with the widget may not be used unless a new API (widget.extract File ( )) is used to extract the file out of the flat-file widget into a location in the file system. One exception is that sound files played through the play ( ) function may work without any changes.

This section discusses how widgets are run and some of the issues that need to be addressed. When a widget is opened, it is run as a separate process. This is done to ensure one widget does not affect the rest of the widgets that a user may use. A widget that is in zip format is unzipped into a special location (C:/Documents and Settings/<user>/Local Settings/Application Data on a PC). A widget that is not zipped is run from where it is located. For this reason, one may not rely on where the widget is. Once the .kon file is located in the widget, the current directory is set to the directory in which the .kon file is located. So for example, if a kon file is in the Contents folder, the current working directory would be Contents. This allows relative paths to Resources to function properly. A .kon file would reference an image as Resources/Image1.png, for example, if its images are in the Resources folder in Contents folder.

When the .kon file is located and the current directory is set, the file is parsed and the objects defined therein are created. After everything is created successfully, the on Load handler is called. Then the widget runs the initialization routine. Note that the on Load handler is typically executed before the widget is made visible. In other words, many widgets set their window to be hidden at first and become visible upon complete execution of the on Load handler. After the onLoad handler is run successfully, the widget is up and running. Note that the next time the widget is run, it is unzipped again. For this reason, one cannot rely on storing information in the widget bundle. Instead, it is preferable to store information in the widget's DataFolder as discussed previously.

The widget engine keeps track of what widgets may be opened automatically. The next time the widget engine is launched, it automatically reopens any widgets that were running at the time when the widget engine was last shut down.

Actions are important in widgets because they are where a user defines how a widget behaves when he interacts with the widget. In one implementation, an action is specified by setting the action to certain JavaScript text. This text is evaluated and run when the user clicks, for example:

<onMouseUp>
print( “hello” );
</onMouseUp>

However, there are at least two limitations: 1) the user may not use the JavaScript ‘this’ object to refer generically to the object for which the action was running; and 2) if the user has several objects with the same code, he may have to duplicate the JavaScript and change the names of the objects to reflect each object to which he has attached the code.

To remedy these limitations, the widget engine supports proper JavaScript functions for these actions. For example, no parameters are sent to the actions. In addition, an onMouseUp handler may receive the x and y coordinates of the mouse instead of inspecting system.event. To use functions, a user may either use a function in the XML (by using an attribute), or set the property to the function to call in JavaScript, as shown below:

<!-- In XML -->
<onMouseUp function=“ myMouseUp”/>
// in Javascript
myImage.onMouseUp = myMouseUp;
// and someplace in the JS code, the function need to be defined:
function myMouseUp( )
{
print( this.opacity );
}

In the XML description, a user may set the <name> property. This defines the global JavaScript object that may be created and bound to the object of which the name is a part. For example, the code

<window name=“main Window” . . . />
creates a JavaScript variable at the global scope with the name mainWindow. Note that all names need to be unique. In addition, since internally these names are used to track objects, they cannot be changed. The widget engine enforces this by making all name properties read-only. When a user creates an object on the fly using JavaScript, the object is given a generic name, such as Image001.

Some provisions are made for debugging the widgets. There is an XML tag “debug” that a user may set to “on” for debugging purposes. When the “debug” tag is set to on, a debug output window will open when a widget is launched. Calls to log( ) or print( ) in the JavaScript code are routed to this debug window. Any errors encountered inside the widget engine are also reported in this window. Note that the debug window will not open unless the debug tag is set to on.

While developing a widget, it is preferable that the debug tag is turned on so that it can inform the user about errors that occurred while the widget is running. For example, if an attribute is spelled wrong, the output window informs the user about this error, along with where in the code the problem may be found.

There are two types of security windows that may appear in the widget engine. The first is a first-run/modification window. On a first run of a widget that the widget engine has not seen before, a window appears to inform the user that a new widget is about to open and ask the user to confirm the action. This is to protect against widgets that may just run without the user's knowledge. Also, if the user allows a widget to run and subsequently the widget is modified, another window appears the next time the widget is launched, informing the user about the modified widget. Again, the user may confirm or deny the request to launch this modified widget.

If a user is in the process of debugging a widget, the user may turn on the debug mode, which may suppress the first-run/modified security windows. Thus the user is not interrupted every time the user modifies the code and reloads the widget.

The second type of window is a ‘sandbox’ window. In one approach, the sandboxed action relates to user's login to his Internet content provider account. The first time a widget attempts to login to his account, a window will appear to alert the user of this fact and ask whether the widget should be granted permission to use the user's data on the account.

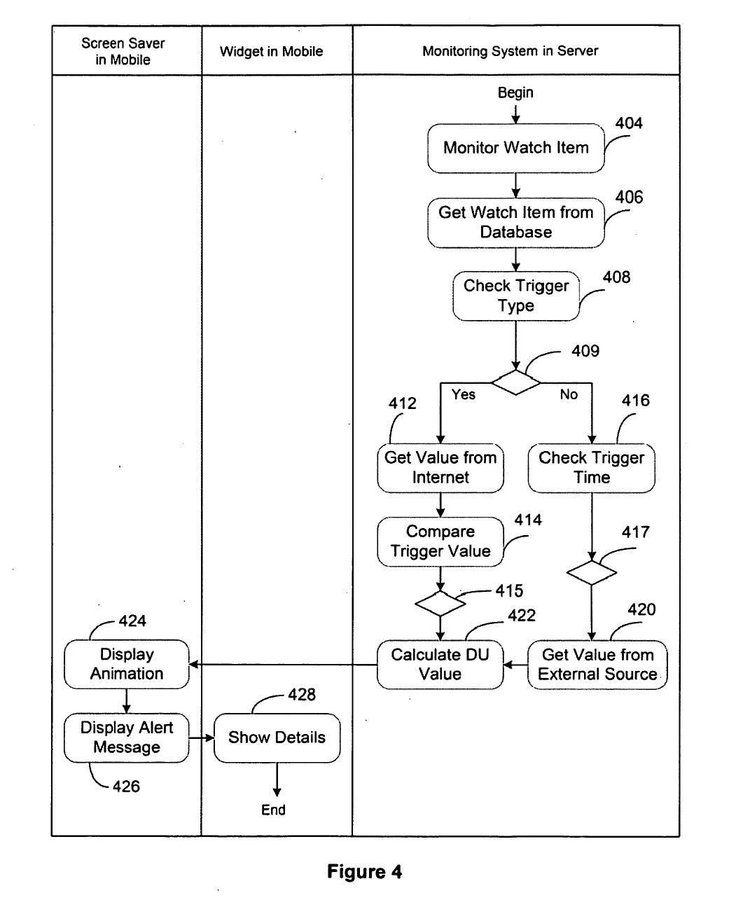

FIG. 4 illustrates a method for monitoring an event according to embodiments of the present invention. The method includes monitoring interactions between a mobile client and a server.

In this example, a list of watch items is used to monitor the information of interest to the user. A user would define the watch items or events he is interested to monitor. Based on the user-defined watch items, the system may initiate push messages that are useful to the user. For example, the user may want the mobile device to inform him when the stock price of company XYZ reaches $500. To achieve this objective, the user may set a watch item that will generate the dynamic screen animation and the alert message when such event happens.

In conventional alert notifications, a purely on/off mechanism is typically used. For example, an alert is sent whenever the user receives an email. However, such on and off type of alert mechanism has a number of issues. First, the user may get too many alerts, for example the user receives an alert for every email he receives, which may be quite disruptive and annoying. Another issue with the conventional on/off alert notification mechanism is that the user may not get any alert at all, if the user-defined preset condition is not met. For example if the user sets the target price of a stock at $400, no alert would be sent to the user if the stock only reaches $399, even though it would be good information for the user to know.

According to embodiments of the present invention, user-defined ranges of display units are employed to generate alert messages to the user. Instead of pin-point a specific value to monitor, the user may define a range of values which the user may be interested. For example, the user may want to keep an eye on fluctuations of the NASDAQ Index without having to go check every minute. He may define a watch item specifying that “inform me whenever the NASDAQ Index goes above or below a certain percentage (e.g. 5%) of its opening market value.” Note that a stock price is merely an example of a watch item. Information may come in various forms, including but not limited to sports scores, weather reports, traffic reports, pollen forecasts, or news announcements.

In block 404, a monitoring program in the server monitors watch items of a user according to a predetermined time interval. The predetermined time interval may be defined by the user (for example every five minutes) or may use a default time interval set by the system (for example every hour). In block 406, when it is time to update the user, the monitoring program gets watch items from a database associated with the server. The watch items are stored in a local memory of the server for subsequent processing. In block 408, the monitoring program checks the trigger type of a watch item. In block 409, a first determination is made as to whether the watch item is of type value trigger or time trigger. If the watch item has the type value trigger (409_yes), the monitoring program continues in block 412. In the alternative, if the watch item has the type time trigger (409_no), the monitoring program moves to block 416. In other embodiments, a combined value trigger and time trigger mechanism may be employed.

In block 412, the monitoring program retrieves a value of the watch item via the Internet. For example, a value of the watch item may be the current price of a stock. In block 414, the retrieved value is compared to the trigger value of the watch item. In block 415, a second determination is made as to whether to send an alert to the user. According to embodiments of the present invention, an alert may be sent if the retrieved value exceeds the trigger value. In the alternative, an alert may not be sent if the retrieved value is within the range of trigger value. For example, if the range of trigger value of a stock has a maximum of $500 and a minimum of $400 and the retrieved value is $510, an alert may be sent to the user. On the other hand, if the retrieved value is $450, no alert would be sent to the user.

In block 416, the monitoring program compares the trigger time of the watch item with the current time. In block 417, a third determination is made as to whether to send an alert to the user. According to embodiments of the present invention, an alert may be sent if the current time is greater than the trigger time of the watch item. For example, if the trigger time is set to 5 P.M. everyday and the current time is 5:05 P.M., an alert may be sent to the user. On the other hand, if the current time is not yet 5 P.M., no alert would be sent to the user. In block 420, the monitoring program retrieves the value of the watch item from an external source, such as the Internet. One example of a value of a watch item is the current price of a stock.

In block 422, the monitoring program calculates a display unit (DU) value for display. The DU value is calculated based on the current value and the watch item settings. For example, if the range of trigger value of a stock has a maximum of $500 and a minimum of $400 and the retrieved value is $510, and the maximum and minimum DU values in watch item settings are 90 and −90 respectively, then the calculated DU value is 90 DU. In one approach, the DU value may be determined by a linear interpolation of the current value in the range of the predefined maximum and minimum DU values in the watch item settings. After the calculation, the DU value and other information related to the watch item are sent from the server to the mobile client.

In block 424, the mobile client displays an animation of the trigger event according to the DU value received from the server. In block 426, the mobile client extracts a message from the watch item alert sent from the server and displays the alert message with the screen saver animation. In block 428, a specific widget in the mobile client corresponding to the watch item displays the details of the alert message when the user clicks on the alert message. The watch item monitoring process ends in block 430.

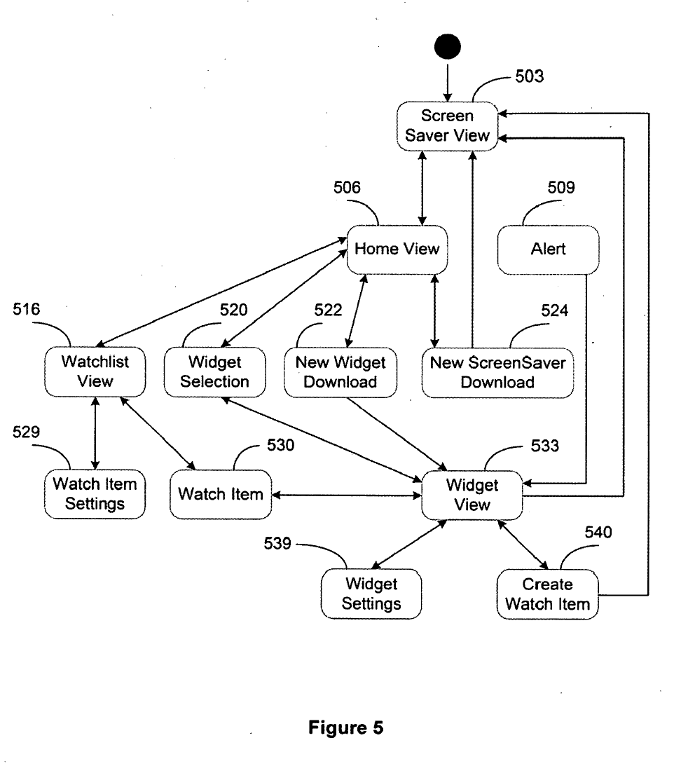

FIG. 5 illustrates a screen control flow diagram for a mobile client according to embodiments of the present invention. The mobile client controls its display with a screen control application. According to embodiments of the present invention, the mobile client may start in a screen saver view 503 that shows a screen saver animation. The mobile client may switch between the screen saver view 503 and a home view 506 in response to certain key presses. The home view 506 acts as the main menu of the application, which shows application widgets supported by the mobile client.

From the screen saver view 503, if the mobile client receives an alert, the alert message is displayed as part of the screen saver. In the display of the alert message 509, it shows the triggered event summary of the watch item.

From the home view 506, it transitions to a watchlist view 516, a widget selection 520, a new widget download 522, or a new screen saver download 524 in response to the user chooses the watchlist option, the select widget option, the download new widget option, or the download new screen saver option, respectively. The user may return to the home view 506 from the watchlist view 516, the widget selection 520, or the new widget download 522 by pressing a Back button. From the new screen saver download 524, it returns to the screen saver view 503 after the download is completed.

From the display of the alert message 509, the user may transition to a widget view 533 and then to a specific widget for handling the alert message via widget selection 520.

In the watchlist view 516, the user is provided with a list of watch item to choose from.

The new widget download screen 522 includes a list of new widgets the user may select for download. Similarly, the new screen saver download 524 includes a list of new screen savers for download.

From the watchlist view 516, the watch item setting may be modified by selecting the settings entry. In response to the settings entry being selected, the screen transitions to a watch item setting 529. The watch item settings 529 contain watch item properties for the user to customize, such as the maximum and minimum DU values for the mobile client. In addition, a user may select a new watch item from the watchlist view 516. In response to the watch items being selected, the screen transitions to a watch item 530. The watch item acts as a shortcut to a widget, which shows the status of the watch item, such as unread alert messages. The user may return from the watch item settings 529 or watch item 530 to watchlist view 516 by pressing a button.

According to embodiments of the present invention, the mobile client supports a shortcut to transition between the watch item 530 and a widget defined by the user. In order to support this feature, the user may switch between the screens of the watch item 530 and the widget view 533 with the press of a button.

From the widget view 533, contents of the selected widget is displayed. For example, a weather widget may include an input field for entering zip code. In addition, the user may choose to modify widget settings or create watch item. In response to the user selects settings option, the screen transitions to a widget settings screen 539, where the user may customize properties of widget settings. On the other hand, if the user selects create watch item option, the screen transitions to a create watch item screen 540, where the user may customize watch item properties, such as trigger type, trigger values, DU values, etc. The user may return from the widget settings 539 and the create watch item 540 to widget view 533. The screen returns from the widget view 533 to the screen saver view when events related to the widgets are completed.

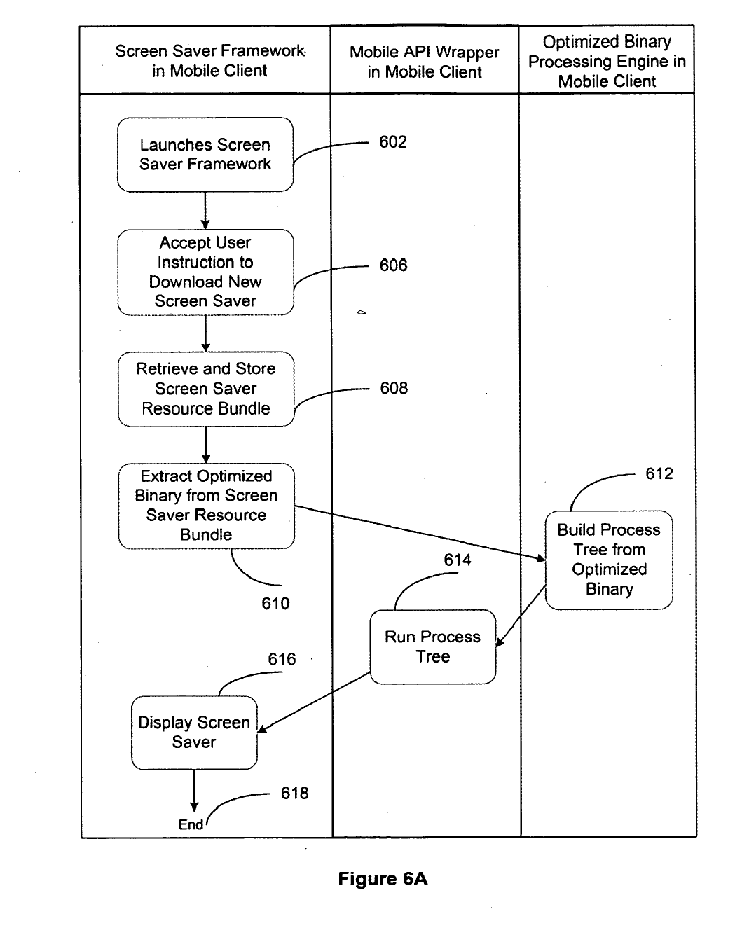

FIG. 6A illustrates an example of screen saver framework in a mobile client according to embodiments of the present invention. In order to support the screen saver framework, the mobile client includes an API wrapper and an optimized binary processing engine. According to embodiments of the present invention, the screen saver framework provides plug-and-play functionalities for the mobile client. The API wrapper provides a layer of abstraction on mobile API that supports a platform independent environment, and the optimized binary processing engine runs scripts in binary format.

The method starts in block 602 the mobile client launches the screen saver framework application. Next in block 606, the application accepts user instruction to download new screen saver by having the user selects a new screen saver for download. In block 608, the application retrieves and stores screen saver resource bundle, which includes the screen saver scripts and resources in a packed format. In block 610, the application extracts the screen saver scripts in binary form from the screen saver resource bundle.

In block 612, the optimized binary processing engine creates a process tree in memory of the mobile client for faster processing. Note that the process tree includes program instructions in a hierarchical tree structure. In block 614, the mobile API wrapper runs the process tree from the memory to generate program instructions for drawing dynamic animations on the screen of the mobile client. In block 616, the screen saver animation is displayed on the screen of the mobile client. The application ends in block 618.

FIG. 6B illustrates an example of a script engine according to embodiments of the present invention. In this example, the script engine is supported by a script submission interface in a mobile client and a device provisioning application in a server. The script submission interface is used for script submission, which can be web-based or can be resided in the mobile client. The device provisioning application stores and provides access to widget and screen saver resources in the server. As shown in FIG. 6B, the script engine is initiated when a user creates and submits a screen saver script in block 623, where the screen saver script includes program instructions for screen saver animation. In block 625, the script submission interface assembles the screen saver script together with its corresponding resources, such as images and sound, into a package.

In block 627, the script submission interface submits the screen saver package to the server. In block 629, the device provisioning application unpacks the screen saver package, which includes program instructions for screen saver animation. In block 631, the server validates the script by checking the screen saver script for errors, such as memory overflow, oversize, etc. In block 633, the server converts the script to an optimized binary format. Next in block 635, the server packs the optimized binary and resource file into a screen saver resource bundle for download, where the screen saver resource bundle is a compact file containing the processed script and resources. In block 637, the server stores the screen saver resource bundle into repository, and the screen saver script in the server is ready for download. The process ends in block 339.

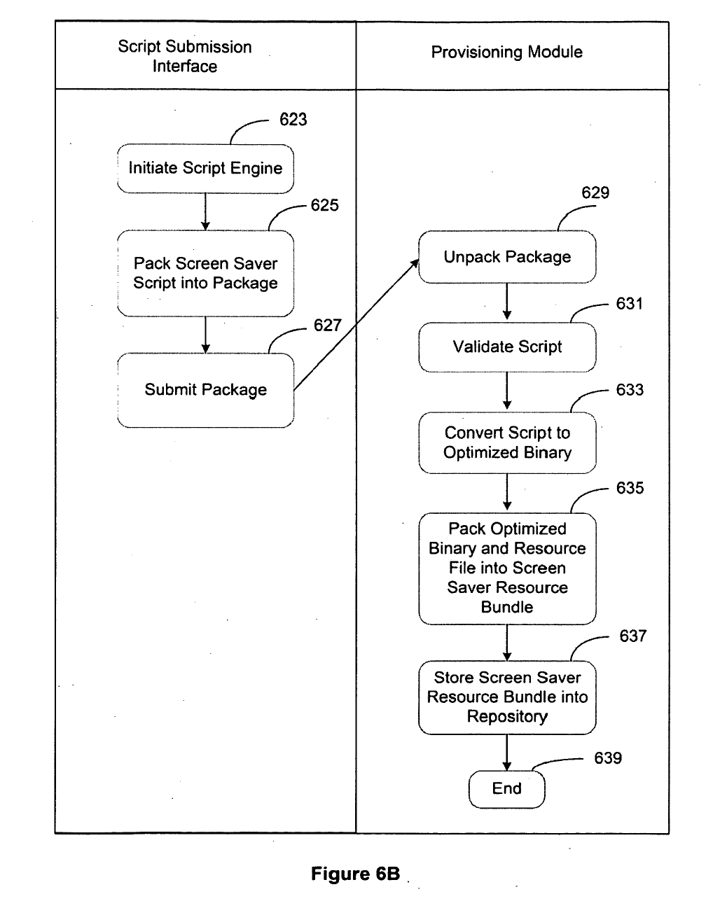

FIG. 7 illustrates a method of implementing dynamic animation according to embodiments of the present invention. As shown in FIG. 7, the display unit (DU) has a positive range of +1 to +100, a negative range of −1 to −100, and a neutral position of DU equals to 0. The dynamic animation may represent the neutral (or idle) position by a bird flying in a level position. Blocks shown by numerals 702, 704, and 706 represent the bird flying in a level position at times T₀, T₁, and T₂ respectively. On the other hand, the dynamic animation may represent the positive range of display unit by a bird flying in upward position. Blocks shown by numerals 708, 710, and 712 represent the bird flying in upward position at times T₀, T₁, and T₂ respectively. Similarly, the dynamic animation may represent the negative range of display unit by a bird flying in downward position. Blocks shown by numerals 714, 716, and 718 represent the bird flying in downward position at times T₀, T₁, and T₂ respectively.

According to embodiments of the present invention, different dynamic animations are used to communicate the status of a monitored event to the user. For example, attention and action may be needed from the user when the display unit has either a positive trend (+1 to +100) or a negative trend (−1 to −100).

As seen above, since an alert notification may be triggered through a range of values, it would not be desirable to bombard a user with push alert messages continuously as in a conventional alert notification mechanism. Instead, the method of using a graphical dynamic animation as shown in FIG. 7 is an effective way to deliver information to the user in a non-intrusive manner.

One effective way to deliver the dynamic animation is to have dynamic animation displayed in the foreground of the mobile device. An approach to accomplish this objective is to design the dynamic animation application as a screensaver application (also referred to as a stand-by application). For example, if the user defines a watch item to monitor the NASDAQ Index, he only needs to glance at the dynamic animation/graphics on the screen of the mobile device in order to tell how well, bad, or stagnant the NASDAQ Index is doing.

It should be noted that although the dynamic animation is described above in the screensaver mode, this features may also be implemented in any user interface page (such as the home page) of a mobile device that does not support a screensaver mode.

FIG. 7 further illustrates examples of themes of dynamic animation according to embodiments of the present invention. As shown in FIG. 7, not only do the themes of dynamic animation provide an easy and effective approach to communication information to users, they also allow users to express their personal preferences and identities. In the example of FIG. 7, a bird flying in level, upward, and downward positions are used to represent the watch item Stock001 in the neutral position, positive range, and negative range respectively. Other graphical representations may be used to demonstrate the neutral position, positive range, and negative range. For example, different city skylines with fireworks may be used to represent the watch item Stock001 in the neutral position, positive range, and negative range. In another example, different baby pictures may be used to represent the watch item Stock001 in the neutral position, positive range, and negative range.

As shown in the examples above, the mobile device provides the tools for creative users to customize their themes of dynamic animation without getting deeply involved in software programming. Note that a theme of a dynamic animation would generally be composed of XML definitions accompanied by its resource files (e.g. graphics, 3D objects, music etc.). Users would not need to modify source codes of these objects in order to create a theme of their choice. According to embodiments of the present invention, an authoring tool as described in FIG. 3 is provided to users to create customized themes. For example, a web-based do-it-yourself (DIY) theme tools may be provided to users for creating their own themes, by downloading their favorite pictures for representing the different screens of the dynamic animation.

There are numerous benefits for implementing dynamic animation for communicating information to a user with a mobile device. First, it may serve as a personal assistant for the user, looking for information, content, and knowledge that the user has expressed interest in. The methodology encompasses a complete spectrum of push-and-pull information delivery mechanisms. The dynamic animation screen can satisfy a user's need for information effectively with a simple glance of the screen.

In other embodiments, the mobile device of the present invention may combine the dynamic animation push mechanism of data delivery with an advertiser sponsored usage. The dynamic animation application may be installed on the mobile devices. This avoids tedious typing of website address on tiny keyboard of the mobile devices. Users may choose their favorite widgets, such as weather widget, news widget, email notification widget, or points-of-interest locator widget. The use of the widgets addresses the need for manually pulling information from the mobile device.

In other embodiments, the mobile device of the present invention may keep track of application updates for users so that they will be informed of the latest updates for their mobile device. By setting a watch item for monitoring the availability of the updates, users may be notified automatically when such updates are available. Through user-defined animations and notification mechanisms, the present invention is able to present information to users without overwhelming them with spam data. The aesthetic dynamic animation not only is present to view, it also provides a simple and effective solution for users to manage their information needs. With a simple glance, user can immediately get a sense of the event they care about.

It will be appreciated that the above description for clarity has described embodiments of the invention with reference to different functional units and processors. However, it will be apparent that any suitable distribution of functionality between different functional units or processors may be used without detracting from the invention. For example, functionality illustrated to be performed by separate processors or controllers may be performed by the same processors or controllers. Hence, references to specific functional units are to be seen as references to suitable means for providing the described functionality rather than indicative of a strict logical or physical structure or organization.

The invention can be implemented in any suitable form, including hardware, software, firmware, or any combination of these. The invention may optionally be implemented partly as computer software running on one or more data processors and/or digital signal processors. The elements and components of an embodiment of the invention may be physically, functionally, and logically implemented in any suitable way. Indeed, the functionality may be implemented in a single unit, in a plurality of units, or as part of other functional units. As such, the invention may be implemented in a single unit or may be physically and functionally distributed between different units and processors.

One skilled in the relevant art will recognize that many possible modifications and combinations of the disclosed embodiments may be used, while still employing the same basic underlying mechanisms and methodologies. The foregoing description, for purposes of explanation, has been written with references to specific embodiments. However, the illustrative discussions above are not intended to be exhaustive or to limit the invention to the precise forms disclosed. Many modifications and variations are possible in view of the above teachings. The embodiments were chosen and described to explain the principles of the invention and their practical applications, and to enable others skilled in the art to best utilize the invention and various embodiments with various modifications as suited to the particular use contemplated.

1. A method for providing dynamic animation of events in a mobile phone, comprising:
identifying an event to be dynamically animated;
defining a set of trigger conditions of the event to be monitored;
monitoring the event according to the set of trigger conditions;
computing a display unit in accordance with a comparison of a status of the event to a corresponding trigger condition of the event;
creating a dynamic animation for display using the display unit; and
displaying the dynamic animation on a display of the mobile phone as a user-defined screen saver, wherein the dynamic animation includes user-defined themes.

2. The method of claim 1, wherein the event to be monitored comprises at least one of:
stock quote;
traffic condition; and
email notification.

3. The method of claim 1, wherein the event to be monitored comprises at least one of:
sports score;
weather condition; and
news announcement.

4. The method of claim 1, wherein the trigger condition comprises at least one of:
a time trigger; and
a value trigger.

5. The method of claim 1, wherein computing a display unit comprises:
determining a trend of the event to be monitored, wherein the trend indicates status of the event has one of a negative trend, a neutral trend, and a positive trend.

6. The method of claim 1, wherein the display unit comprises:
a user-defined positive range indicating degree of a favorable change in status of the event;
a user-defined negative range indicating degree of a unfavorable change in status of the event; and
a neutral position indicating no change in status of the event.

7. The method of claim 6, wherein the user-defined positive and negative ranges of the display unit are scalable.

8. The method of claim 1, further comprising:
generating an alert message in response to the display unit; and
displaying the alert message on the display.

9. The method of claim 1, wherein the dynamic animation comprises at least one of:
images, graphical objects, sound, text, and hyperlinks for representing status of the event.

10. The method of claim 1, further comprising:
displaying the dynamic animation as a screen saver of the mobile device.

11. The method of claim 1, wherein the method is performed by a data processor according to computer-executable instructions stored on a computer-readable medium.

12. A computer program product for monitoring occurrence of an event using dynamic animation, comprising a non-transitory medium storing executable program code, the computer program product comprising:
a widget framework that operates widgets for monitoring occurrence of an event;
a screen saver framework that displays occurrence of the event as a dynamic animation in a user-defined screen saver in a mobile phone, wherein the dynamic animation includes user-defined themes;
a binary processing engine that runs screen saver scripts and widget scripts in binary format; and
a mobile application programming interface wrapper that provides a layer of abstraction for creating a platform independent environment.

13. The computer program product of claim 12, wherein the widget framework comprises:
pre-installed widgets that monitor events of common interest; and
user-defined widgets that monitor events defined by a user.

14. The computer program product of claim 12, wherein the widget framework further comprises:
a watchlist manager that handles creation, deletion, and modification of watch items; and
a message handling module that handles advertiser sponsored messages.

15. The computer program product of claim 12, wherein the screen saver framework comprises:
a user-defined screen saver that displays dynamic animation of user-defined themes, wherein the user-defined themes indicate status of an event over time.

16. The computer program product of claim 12 further comprises a web interface that includes:
a widget authoring tool that allows users to create user-defined widgets;
a screen saver authoring tool that allows users to create user-preferred themes for screen saver;
a sponsored message submission interface that allows advertisers to submit advertisements; and
a user account management interface that allows users to manage their accounts.

17. A system for generating dynamic animation of events, comprising:
at least one processing unit for executing computer programs;
a user interface for receiving and communicating information with a user;
a memory for storing data in association with the monitoring occurrence of an event using dynamic animation;
a provisioning module for accessing resources stored in the system, wherein the provisioning module includes screen saver resource bundles for providing access to screen saver resources, and the screen saver resources includes a user-defined screen saver configured to display dynamic animation of user-defined themes in a mobile phone;
a user profile module for creating and storing user profiles;
a data optimization module for optimizing data for transmission between the system and mobile clients;
a dynamic alert monitoring module for monitoring user-defined events, and
a sponsored message processing module for handling advertising requests from advertisers.

18. The system of claim 17, wherein the provisioning module further comprises:
widget resource bundles for providing access to widget resources.

19. The system of claim 17, wherein the data optimization module comprises:
a script conversion module for converting a script to a binary compacted format with image and sound resources; and
a data feed conversion module for converting a data feed to binary compacted format for transmission to mobile clients.

20. The system of claim 17, wherein the dynamic alert monitoring module comprises:
a time-triggered alert module for monitoring occurrence of an event based on a time- trigger set by the user;
a value-triggered alert module for monitoring occurrence of the event based on a value- trigger set by the user.

21. The system of claim 17, wherein the sponsor message processing module comprises:
a sponsor profile for storing profiles of advertisers and corresponding advertisements.
